(19) United States
(12) Patent Application Publication
(10) Pub. No.: US 2011/0247754 A1
(43) Pub. Date: Oct. 13, 2011

(54) Method For Vacuum Laminating Glass Without The Use Of Preconditioned Interlayer Material Or An Autoclave

(76) Inventor: Douglas M. Canfield, Piermont, NY (US)

(21) Appl. No.: 13/085,224

(22) Filed: Apr. 12, 2011

Related U.S. Application Data
(60) Provisional application No. 61/323,199, filed on Apr. 12, 2010.

(51) Int. Cl. B32B 37/02; B32B 37/14; B32B 37/06

(52) U.S. Cl. 156/285

(57) ABSTRACT

A method for manufacturing a laminated product having the steps of placing at least one interlayer between at least two sheets of material to form a laminated product and then placing the product in a chamber. Heating the product to a first temperature below a temperature at which the grooves in the interlayer will flatten and above ambient temperature to enhance removal of air and moisture. Removing the air and the moisture from the chamber, and then heating the product to a second temperature corresponding to a curing temperature of the interlayer, the second temperature being higher than the first temperature.

### CROSS-REFERENCE TO RELATED APPLICATIONS

The present application claims the benefit under 35 U.S.C. §119(e) of U.S. Provisional Patent Application Ser. No. 61/323,199 filed on Apr. 12, 2010. The contents of Provisional Patent Application 61/323,199 are hereby incorporated by reference.

### FIELD OF THE INVENTION

The present invention relates generally to a method of manufacturing laminated glass, and more specifically, relates to a method for manufacturing laminated glass without the need for a preconditioned interlayer or an autoclave.

### BACKGROUND OF THE INVENTION

Vacuum batch or continuous laminating systems are used to laminate at least two pieces of glass or plastic using an interlayer material to adhere the glass or plastic layers together between each layer. Continuous laminating systems have been proven to be effective when using different interlayer materials such as urethane, ethylene vinyl acetate (EVA), and Polyvinyl Butyral (PVB). The advantage of using a batch laminating system is that an autoclave is not required, saving the expense of using and maintaining an autoclave, which requires floor space and operating expenses. The advantage of using a continuous laminating system is that it provides higher levels of production than a batch laminating system.

The process of vacuum laminating glass requires the use of a container, which encloses the laminate between two layers of a material such as a silicone blanket, flexible film, or another material that can be sealed. The container is used to create a vacuum, which results in pressure being applied from the atmosphere onto the laminate, while the vacuum removes the air and moisture within. The vacuum container, or bag, may be made from layers of material that are taped together or may be made from layers of material that are clamped together, forming a vacuum tight seal. A port is typically provided in the container to connect a vacuum pump to the vacuum chamber, which is used to remove the air and the moisture from the container. The container may also be made by using vacuum ring, which is flexible seal that is place around the edge of the laminate to draw the vacuum from the edges.

One of the more common materials used in laminated glass application is PVB. PVB has advantages for hurricane, safety, decorative, and noise reduction laminated glass applications. However, PVB also has disadvantages in its physical attributes or properties. PVB contains a small quantity of moisture in the material and this moisture emerges from the PVB material during processing, which results in champagne like bubbles in the finished product during the laminating process. Additionally, entrapped air bubbles are also a concern when laminating glass.

Glass laminates made from PVB as the interlayer material, and all other types of glass or plastic laminates containing bubbles are considered to be a defective product, as bubbles are an unwanted byproduct of the laminating process. Interlayer materials that contain moisture results in the laminated product having clarity problems. Thus, there is a need to form a glass laminated product that has no bubbles.

In order to accomplish this need, most PVB laminating is manufactured with a final processing/curing in an autoclave. The autoclave applies heat and pressure during the curing process to prevent the moisture in the solution within the PVB from coming out as bubbles. An alternate solution is to precondition the PVB to reduce its moisture content so as to reduce the possibility of bubbles forming during the laminating process.

Manufacturers of PVB including DuPont®, Solutia®, and Trosifol® (Kuraray®), for the non-autoclave process, either offer a special low moisture PVB or recommend that the PVB be conditioned (dried) prior to laminating. This low moisture PVB is more expensive than non-conditioned, standard PVB. Additionally, conditioning or drying standard PVB takes time and money, as the drying process is typically done in a heated environment or a dehumidification cabinet. Furthermore, working with preconditioned PVB requires rapid assembly of the laminate so that the PVB does not reabsorb moisture from the room air or a special low moisture environmental room. These are important drawbacks when working with both standard and preconditioned PVB.

Companies that work with PVB discuss standard operating protocols for this material. For example, Trosifol® (Kuraray®) states on their website, www.trosifol.com, that when using Trosifol HR 100 PVB, a product specifically made for non-autoclave laminating, that this product should be dried overnight at a relative humidity of less than 10% and a temperature of less than 25° C. Trosifol® recommends that its sheets should be dried singularly, which requires large amounts of space and increases the difficulty of handling these sheets if the sheets are large.

Solutia®'s Saflex®, in their instructions for Vacuum Non-Autoclave published in April 2007, discuss the use of low moisture interleaved material and storage. The instructions suggest that the low moisture PVB be assembled between the glass sheets within 30-60 seconds to minimize moisture pickup.

DuPont® recommends drying their standard PVB in a low humidity atmosphere.

Typical moisture contents of standard PVB material made for the autoclave process is between 0.4-0.5%. Preconditioned materials have a reduced moisture level of between 0.2-0.3%.

Thus, it desirable to develop a method for vacuum laminating glass without the use of a preconditioned interlayer material, as conditioning or drying standard PVB takes time and money, as the drying process is typically done in a heated environment or a dehumidification cabinet.

It is further desirable to develop a method for vacuum laminating glass without the use of an autoclave, as use of an autoclave requires additional expenses, such as requiring additional floor space and the additional operating expense of the autoclave.

### SUMMARY OF THE INVENTION

The invention is directed toward a vacuum laminating process that does not require the use of an autoclave, preconditioned PVB material, or a low-humidity environment in order to condition the interlayer material to prevent air and moisture bubbles from forming in the laminated glass.

This method and process for vacuum laminating two or more pieces of glass or plastic avoids using interlayer materials that typically contain small amounts of moisture, which in the past, required an autoclave for final processing to prevent the moisture within the interlayer materials from forming moisture bubbles resulting in a defective product, or which in the past required preconditioning the interlayer material prior to laminating, so as to reduce the moisture content to a point where the process would not produce a defective product that had moisture bubbles. Additionally, it is an object of the present invention to provide a method for removing trapped air which can also create bubble defects in the laminated product.

These and other objects of the present invention are achieved by a method for manufacturing a laminated product comprising the steps of placing at least one interlayer between at least two sheets of material to form a laminated product and placing the product in a chamber. The product is heated to a first temperature below a temperature at which the interlayer material will tack or seal and above ambient temperature. Air and moisture is removed from the chamber. The product is then heated to a second temperature corresponding to a curing temperature of the interlayer, the second temperature being higher than the first temperature.

In some embodiments, the chamber is made from a silicone laminated fiberglass. In some of these embodiments, the chamber is made from a silicone blanket having a metal powder mixed into a silicone material to enhance thermal conductivity. In some of these embodiments, the chamber is made from a high temperature material. In some of these embodiments, the first temperature is less than a temperature at which grooves in the interlayer are flattened. In some of these embodiments, the chamber is heated using an infrared source and air is circulated throughout the chamber. In some embodiments, the manufacturing is performed using a batch process or a continuous process.

In certain of these embodiments, the two sheets of material are made of glass, plastic, or metal. In certain of these embodiments, the chamber is a vacuum bag or a vacuum ring. In certain of these embodiments, a decorative film placed between at least two sheets of interlayer. In certain of these embodiments, the at least one interlayer is made from PVB, an ionomer, or another tacking material. In certain of these embodiments, air and moisture is removed from the chamber prior to the heating process. In certain of these embodiments, the product is heated to a third temperature prior to removing the air and moisture, the third temperature being greater than the first temperature and less than the second temperature. In certain of these embodiments, the air and moisture is continuously removed from the chamber after the product has been placed in the chamber. In certain of these embodiments, the air and moisture is ceased being removed after the product has reached the second temperature.

In another embodiment of the present invention is a method for manufacturing a laminated product from at least two sheets of material and one interlayer material comprising the steps of placing a product to be laminated in a chamber and heating the product to a first temperature. Removing the air and the moisture from the chamber, and heating the product to a second temperature, the second temperature being higher than the first temperature.

In some of these embodiments, the chamber is made from a silicone laminated fiberglass. In some of these embodiments, the chamber is made from a silicone blanket having a metal powder mixed into silicone material to enhance thermal conductivity. In some of these embodiments, the chamber is made from a high temperature material. In some of these embodiments, the first temperature is less than a temperature at which grooves in the interlayer material are flattened. In some of these embodiments, the chamber is heated using an infrared source and air is circulated throughout the chamber. In some of these embodiments, the two sheets of material are made of glass, plastic, or metal. In some of these embodiments, the chamber is a vacuum bag or a vacuum ring. In some of these embodiments, a decorative film is placed between two interlayers, which are sandwiched between the at least two sheets of material. In some of these embodiments, the at least one interlayer is made from PVB, an ionomer, or another tacking material. interlayer is made from PVB, an ionomer, or another tacking material. In certain of these embodiments, the product is heated to a third temperature prior to removing the air and moisture, the third temperature being greater than the first temperature and less than the second temperature. In certain of these embodiments, the air and moisture is continuously removed from the chamber after the product has been placed in the chamber. In certain of these embodiments, the air and moisture is ceased being removed after the product has reached the second temperature.

In another embodiment of the present invention is a method for manufacturing a laminated product from at least two sheets of material and one interlayer material comprising the steps of placing a product to be laminated in a chamber and removing air and moisture from the chamber. The product is heated to a first temperature. Additional air and moisture is removed from the chamber. The product is then heated to a second temperature, the second temperature being higher than the first temperature.

In some of these embodiments, the chamber is made from a silicone laminated fiberglass. In some of these embodiments, the chamber is made from a silicone blanket having a metal powder mixed into silicone material to enhance thermal conductivity. In some of these embodiments, the chamber is made from a high temperature material. In some of these embodiments, the first temperature is less than a temperature at which grooves in the interlayer material are flattened. In some of these embodiments, the chamber is heated using an infrared source and air is circulated throughout the chamber. In some of these embodiments, the two sheets of material are made of glass, plastic, or metal. In some of these embodiments, the chamber is a vacuum bag or a vacuum ring. In some of these embodiments, a decorative film is placed between two interlayers, which are sandwiched between the at least two sheets of material. In some of these embodiments, the at least one interlayer is made from PVB, an ionomer, or another tacking material. In certain of these embodiments, air and moisture is removed from the chamber prior to the heating process. In certain of these embodiments, the product is heated to a third temperature prior to removing the air and moisture, the third temperature being greater than the first temperature and less than the second temperature. In certain of these embodiments, the air and moisture is continuously removed from the chamber after the product has been placed in the chamber. In certain of these embodiments, the air and moisture is ceased being removed after the product has reached the second temperature.

### BRIEF DESCRIPTION OF THE DRAWINGS

FIG. 1 is a flowchart of a method for manufacturing a laminated product according to one embodiment of the present invention.

FIG. 2 is a flowchart of a method for manufacturing a laminated product according to another embodiment of the present invention.

FIGS. 3a-b are cross-sectional views of a laminated product according to FIG. 1 and FIG. 2.

FIG. 4 is a representative view of a vacuum chamber according to the present invention.

### DETAILED DESCRIPTION OF THE INVENTION

The exemplary embodiments of the present invention may be further understood with reference to the following description and the related appended drawings, wherein like elements are provided with the same reference numerals. The exemplary embodiments of the present invention are related to a method for manufacturing a laminated product using a batch or continuous process. Specifically, the method heats the laminated product and removes air and moisture prior to curing the laminated product. The exemplary embodiments are described with reference to a laminated product, but those skilled in the art will understand that the present method may be implemented in any method that involves curing a product.

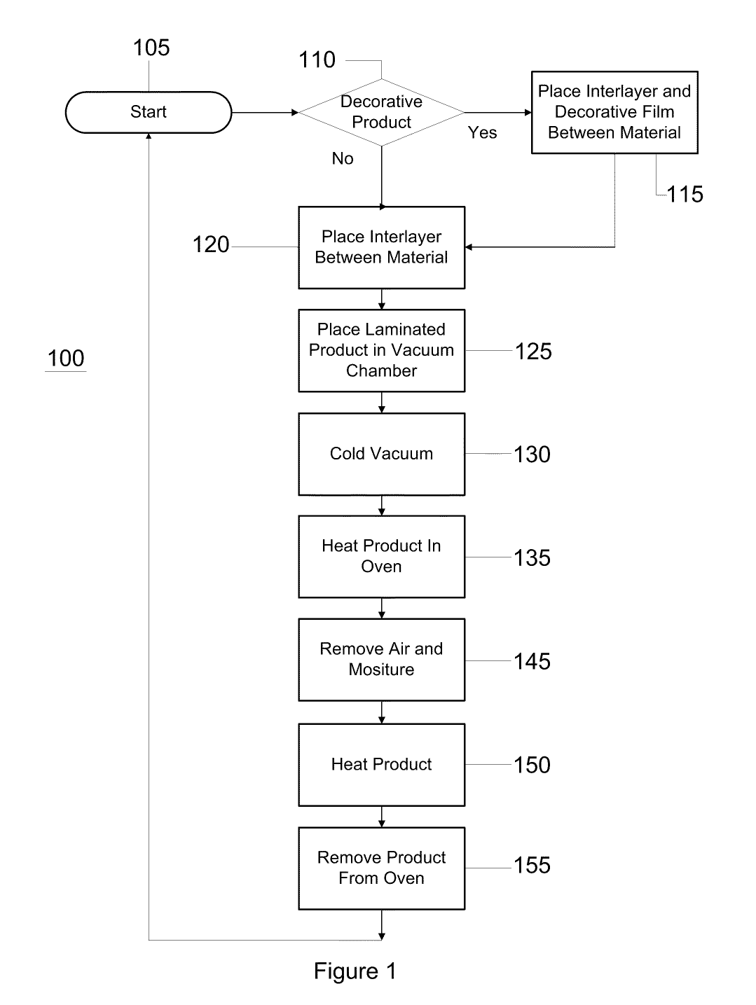

As best seen in FIG. 1, a flowchart of method 100 for manufacturing a laminated product is shown. In step 105, the manufacturing of the laminated product begins. At step 110, a determination is made of whether the product will be used as a decorative product. A decorative product may incorporate a decorative film inside of the laminated product to add style or decoration to the laminated product. The decorative film may be a decorative pattern, or a picture, or any other form of decoration to add style to the laminated product. During manufacturing, the decorative film and the interlayer material are placed between the layers of the material at step 115. At step 110, if the laminated product is not determined to be a decorative product, no decorative film is used and only the interlayer is placed between the material being laminated.

The interlayer is a layer of material that is placed between the product to be laminated. The interlayer acts as an adhesive, allowing multiple layers of material to be adhered to each other. There may be only a single laminated layer such that two layers of the material are adhered using a single interlayer. However, multiple laminated layers may be manufactured allowing for three or more layers of the material to be adhered together using multiple layers of the interlayer material. Additionally, as different interlayers come in different thicknesses, multiple layers of the interlayer may be used to form the desired thickness of the interlayer.

The interlayer material is textured, may be flexible or rigid, and has ridges formed on the material. In general, a higher texture material works better than lower textured material, however, method 100 works for both high textured and low textured interlayer materials. The interlayer may also have various colors and/or color arrangements, that may include various colors and/or various color patterns. Additionally, the interlayer material may be composed of a PVB material, and ionomer, a tacking material, any other known material used in an interlayer material, or a combination of materials. The choice of the characteristics of the interlayer may depend on the material of product being laminated or may depend on the final destination of the laminated product, such as requiring a waterproof seal.

When applying the interlayer material to the laminated product, sheets of similar size to the laminated product may be preformed and applied to the laminated material. The interlayer may also be fitted into a frame that opens and closes, allowing for a quick application of the interlayer to the laminated material.

At step 115, both the decorative film and the interlayer are placed between the laminated material. At step 120, only the interlayer is placed between the laminated material. These steps are typically mutually exclusive. The laminated material may be glass, for example if the laminated product were to be used as a safety glass. The laminated material may also be plastic, metal or any other material that can be laminated. Additionally, the laminated product may be composed of a combination of different materials. At step 125, the entire product to be laminated, including any decorative films is placed inside of a chamber. The chamber may be a vacuum container, a vacuum bag, or may be contained within a vacuum ring. The vacuum container, or vacuum bag, may be made from a clear or opaque film, from a blanket or other flexible material that allows heat to be transferred through to the laminated product, or may be made from transfers such as convection, conduction, radiation, or a combination thereof. If the vacuum container is made from a vacuum ring, then convection, conduction, and radiation may be incorporated into the heating process.

Typical vacuum chambers are between 3-4 mm thick. The thickness of the chamber decreases the effectiveness of the heating process. If a silicone laminated fiberglass is used, however, the thickness of each chamber may be less than 0.5 mm thick. Additionally, the. The chamber may also be made of a dark colored material to aid in the thermal conductivity of the chamber. The vacuum chamber may be composed of a silicone blanket, which is composed of a silicone material mixed with a metal powder, this allows for better thermal conductivity. The chamber may also be composed of another high temperature film material less than 0.25 mm thick. It should be noted, that the above compositions and sizes are purely exemplary, and the thickness of the chamber may be varied to be smaller or larger than 0.25 mm.

At step 130, the laminated product is cold vacuumed. To aid in the removal of air and moisture during the curing process, the laminated product is cold vacuumed. The cold vacuuming may take place at ambient temperature, at a temperature below ambient temperature, or the product may be heated above ambient temperature but below the first temperature to be cold vacuumed. This process may take place outside of the oven, or the laminated product, including vacuum chamber, may be placed inside of an oven and cold vacuumed prior to being heated. By cold vacuuming the laminated product prior to be heated, the time required to initially heat the laminated product and remove the air and moisture (see below) is significantly reduced. The entire process, including cold vacuuming, can take up to 70% less time than a typical laminating process.

At step 135, the laminated product is placed into an oven and heated to a first temperature. The first temperature is generally above the ambient temperature of the room that the laminated product is stored in, but is lower than the temperature at which the interlayer cures and forms a unitary laminated product. The first temperature may be as low as 60 degrees Fahrenheit, or less. The temperature of the first heating process may depend on the height of the grooves and the texture of the interlayer material. As long as grooves are present on the interlayer material, air and moisture may be released from the interlayer material. Heating of the interlayer material, above a certain temperature dependent on the type of interlayer material, flattens out the grooves. Therefore, it is preferable to heat the interlayer material to a temperature below at which the grooves of the interlayer material disappear. This allows for the continuous removal of air and moisture from the vacuum chamber, and enhances the removal of the air and the moisture.

The amount of time that the laminated product may be heated to the first temperature depends on the size of the laminated product, the material of the laminated product, the material of the interlayer, and the moisture content of the laminated product. Once the chamber has been heated to the desired first temperature, and held there for a period of time, the additional air and moisture present in the chamber is removed at step 145. This may be done through a vacuum, or through any known method of removing air and moisture from an enclosed space. The air and moisture may also be continuously removed during the cold vacuuming process and through the different heating stages. Continuous removal of air and moisture through method 100 allows for more air and moisture to be removed then single stage removal of air and moisture.

Once the air and moisture has been removed from the vacuum chamber, the product is heated to a second temperature at step 150. The second temperature corresponds to the curing temperature of the interlayer material. The laminated product is heated, at the second temperature, until the curing process is complete, whereby it is then removed from the oven at step 155, where another curing process may take place. The laminated product may be removed and cooled outside of the oven, or the laminated product may be left in the oven to cool. However, it is preferable that the laminated product not be taken out of the vacuum chamber until it has cooled.

Air may be circulated throughout the oven to provide a more uniform heating of the laminated product and to provide cooling of the vacuum chamber. If the vacuum chamber gets too hot, the chamber may be damaged. Infrared heat may also be used to heat the laminated product. The circulation of air and the use of infrared may take place during both heating stages.

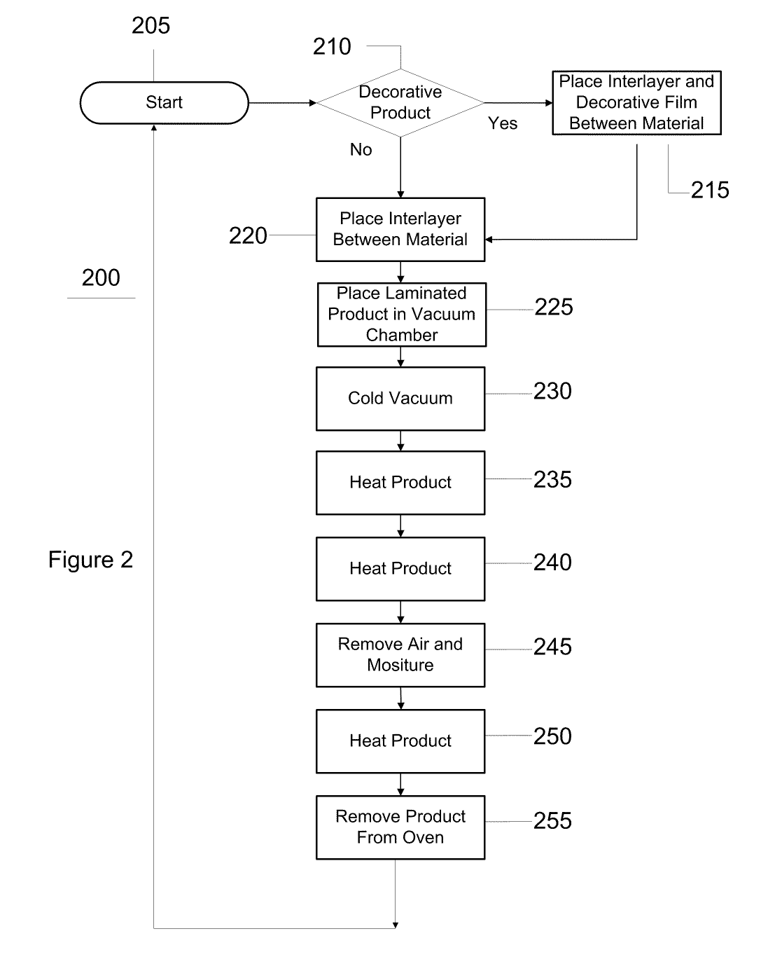

As best seen in FIG. 2, a flowchart of method 200 for manufacturing a laminated product is shown. Method 200 is similar to method 100, except that an additional heating step is added in at step 240. At step 235, the laminated product is heated to a first temperature, similar to that of method 100. At step 240, the laminated product is heated to a second temperature, greater than the first temperature, yet less than the curing temperature of the interlayer material. The laminated product is held at the second temperature for a period of time dependent on the size of the laminated product, the material of the laminated product, the material of the interlayer, and the moisture content of the laminated product. After the laminated product has been heated to a second temperature at step 240, additional air and moisture from the vacuum chamber is removed at step 245. At step 250, the laminated product is heated to a third temperature corresponding to the curing temperature of the interlayer material. Finally, at step 255, the laminated product is removed from the oven. While method 100 and 200 show the laminated product heated to two different and three different temperatures respectively, additional heat points may be incorporated into the curing process depending on the laminated product.

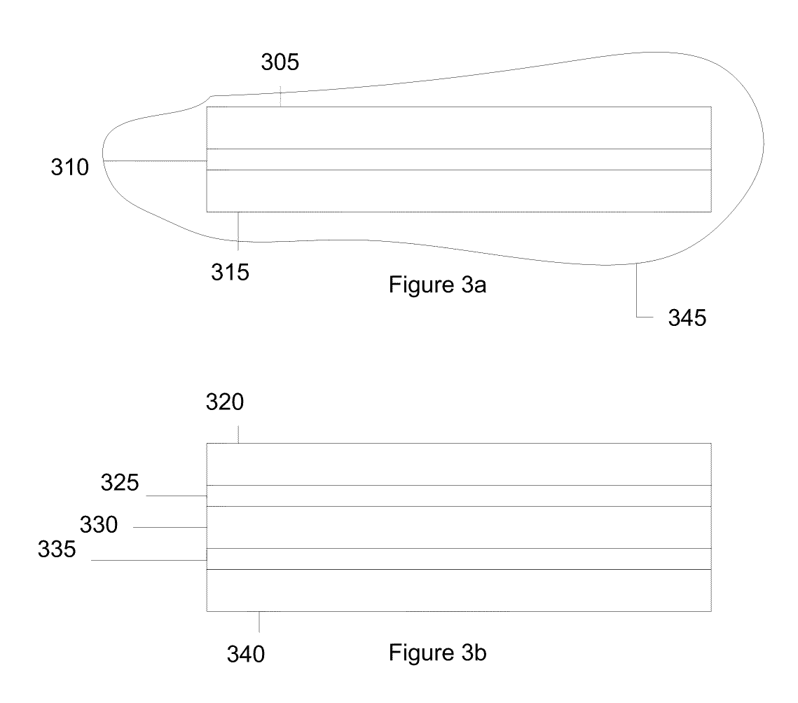

As best seen in FIGS. 3a-b, a cross-sectional view of a laminated product according to FIGS. 1 and 2, are shown. Material layers 305 and 315, may be made of glass, plastic, metal, or any other material that is desired to be laminated, and may have an interlayer material 310 sandwiched in between. During the curing process, the interlayer material joins material layers 305 and 315 together to form a laminated product. If more than two layers of material is desired, then interlayer materials 325 and 335 may be sandwiched together between material layers 320, 330, and 340. In some embodiments, there may be even more interlayers and the interlayers may be made of various materials. Prior to heating the laminated product, the laminated product is placed in a vacuum chamber 345. As stated above, the vacuum chamber may be a vacuum container, a vacuum bag, or may be contained within a vacuum ring.

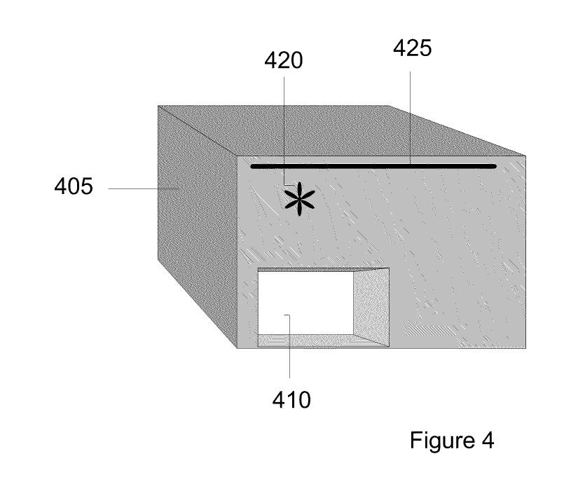

As best seen in FIG. 4, a representative view of an oven 405 is shown. Oven 405 may be a typical curing oven having a door 410 for the laminated product, including vacuum chamber, to enter and exit. Oven 410 may have a second door (not shown) for the laminated product to enter and exit through. The use of a second opening allows the laminated product to cool much quicker than a standard oven, if the laminated product is cooled inside of the oven. Oven 405 contains a fan 420 to provide for the circulation of air during the lamination process. Finally, Infrared source 425 may be incorporated to provide a more uniform and controlled heat. Infrared source 425 may be placed above or below the laminated product, or two infrared sources may be used, one above and one below the surface of the laminated product.

Methods 100 and 200 have the advantage in that the interlayer does not need to be preconditioned or dried prior to the batch laminated process. This saves time, as the product may need to sit in a low humidity area for a length of time to remove the moisture, and saves money by not requiring preconditioned interlayer material or the need for a large storage space to store the material until the moisture has been removed. Additionally, methods 100 and 200 can be used with interlayer materials having a moisture level higher than 0.6%, although preferably the moisture level would be approximately 0.5%, and more preferably between 0.2%-0.3% to enhance the process capabilities.

The interlayer material is preferably stored in a low humidity cabinet so as to prevent the interlayer from absorbing additional moisture. Additionally, the interlayer material may have a moisture barrier plastic film interleaved with the interlayer, protecting the interlayer from absorbing additional moisture.

It would be appreciated by those skilled in the art that various changes and modification can be made to the illustrated embodiment without departing from the spirit of the invention. All such modification and changes are intended to be covered hereby.

What is claimed is:

1. A method for manufacturing a laminated product comprising the steps of:
placing at least one interlayer between at least two sheets of material to form a laminated product;
placing the product in a chamber;
heating the product to at least a first temperature below a temperature at which the interlayer will tack or seal and above ambient temperature;
removing air and moisture from the chamber; and
heating the product to a second temperature corresponding to a curing temperature of the interlayer, the second temperature being higher than the first temperature.

2. The method of claim 1, wherein the chamber is made from a silicone laminated fiberglass.

3. The method of claim 1, wherein the chamber is made from a silicone blanket having a metal powder mixed into a silicone material to enhance thermal conductivity.

4. The method of claim 1, wherein the chamber is made from a high temperature material.

5. The method of claim 1, wherein the first temperature is less than a temperature at which grooves in the interlayer are flattened.

6. The method of claim 1 further comprising heating the chamber using an infrared source and circulating air throughout over the chamber.

7. The method of claim 1, wherein the two sheets of material are made of one of at least glass, plastic, and metal.

8. The method of claim 1, wherein the chamber is one of at least a vacuum bag and a vacuum ring.

9. The method of claim 1, further comprising placing a decorative film between at least two sheets of interlayer.

10. The method of claim 1, wherein the at least one interlayer is made from one of at least PVB, an ionomer, and another tacking material.

11. The method of claim 1, wherein the laminated product is manufactured using one of a batch process and a continuous process.

12. The method of claim 1, further comprising removing the air and the moisture from the vacuum chamber prior to heating the product to the first temperature.

13. The method of claim 1, further comprising heating the product to a third temperature prior to removing the air and moisture, the third temperature being greater than the first temperature and less than the second temperature.

14. The method claim 1, further comprising continuously removing air and moisture from the chamber after the product has been placed in the chamber.

15. The method of claim 14, further comprising ceasing removal of the air and moisture once the product after the second temperature has been reached.

16. A method for manufacturing a laminated product from at least two sheets of material and one interlayer material comprising the steps of:
placing a product to be laminated in a vacuum chamber;
heating the product to a first temperature;
removing air and moisture from the chamber; and
heating the product to a second temperature, the second temperature being higher than the first temperature.

17. The method of claim 16, wherein the chamber is made from a silicone laminated fiberglass.

18. The method of claim 16, wherein the chamber is made from a silicone blanket having a metal powder mixed into silicone material to enhance thermal conductivity.

19. The method of claim 16, wherein the chamber is made from a high temperature material.

20. The method of claim 16, wherein the first temperature is less than a temperature at which grooves in the interlayer are flattened.

21. The method of claim 16, further comprising heating the chamber using an infrared source and circulating air throughout over the chamber.

22. The method of claim 16, wherein the two sheets of material are made of one of at least glass, plastic, and metal.

23. The method of claim 16, wherein the vacuum chamber is one of at least a vacuum bag and a vacuum ring.

24. The method of claim 16, further comprising placing a decorative film between two interlayers, which are sandwiched between the at least two sheets of material.

25. The method of claim 16, wherein the at least one interlayer is made from one of at least PVB, an ionomer, and another tacking material.

26. The method of claim 16, further comprising heating the product to a third temperature prior to removing the air and moisture, the third temperature being greater than the first temperature and less than the second temperature.

27. The method claim 16, further comprising continuously removing air and moisture from the chamber after the product has been placed in the chamber.

28. The method of claim 27, further comprising ceasing removal of the air and moisture once the product after the second temperature has been reached.

29. A method for manufacturing a laminated product from at least two sheets of material and one interlayer material comprising the steps of:
placing a product to be laminated in a chamber;
removing air and moisture from the chamber;
heating the product to a first temperature;
removing additional air and moisture from the chamber; and
heating the product to a second temperature, the second temperature being higher than the first temperature.

30. The method of claim 29, wherein the chamber is made from a silicone laminated fiberglass.

31. The method of claim 29, wherein the chamber is made from a silicone blanket having a metal powder mixed into silicone material to enhance thermal conductivity.

32. The method of claim 29, wherein the chamber is made from a high temperature material.

33. The method of claim 29, wherein the first temperature is less than a temperature at which grooves in the interlayer are flattened.

34. The method of claim 29, further comprising heating the chamber using an infrared source and circulating air throughout over the chamber.

35. The method of claim 29, wherein the two sheets material are made of one of at least glass, plastic, and metal.

36. The method of claim 29, wherein the vacuum chamber is one of at least a vacuum bag and a vacuum ring.

37. The method of claim 29, further comprising placing a decorative film between two interlayers, which are sandwiched between the at least two sheets of material.

38. The method of claim 29, wherein the at least one interlayer is made from one of at least PVB, an ionomer, and another tacking tacking material.

39. The method of claim 29, further comprising heating the product to a third temperature prior to removing the air and moisture, the third temperature being greater than the first temperature and less than the second temperature.

40. The method claim 29, further comprising continuously removing air and moisture from the chamber after the product has been placed in the chamber.

41. The method of claim 40, further comprising ceasing removal of the air and moisture once the product after the second temperature has been reached.
